(19) United States
(12) Patent Application Publication
(10) Pub. No.: US 2026/0071649 A1
(43) Pub. Date: Mar. 12, 2026

(54) PRELOADED BEARING DEVICE AND PRELOAD ADJUSTMENT METHOD

(71) Applicant: HONDA MOTOR CO., LTD., TOKYO (JP)

(72) Inventors: Takashi YOSHIDA, TOKYO (JP); Shota HASHIMOTO, TOKYO (JP); Takahiro KOGA, TOKYO (JP)

(21) Appl. No.: 19/320,037

(22) Filed: Sep. 5, 2025

(30) Foreign Application Priority Data
Sep. 11, 2024 (JP) 2024-157196

(51) Int. Cl. F16C 25/08; F16C 19/54; F16C 43/04

(52) U.S. Cl. CPC F16C 25/083; F16C 19/548; F16C 43/04; F16C 2229/00

(57) ABSTRACT

A preloaded bearing device includes a first angular bearing unit, a second angular bearing unit, and a preload applying mechanism. The preload applying mechanism generates a preload by elastically pressing, in the axial direction, a first outer ring of the first angular bearing unit and a second outer ring of the second angular bearing unit. A first preload applying unit is disposed between the first outer ring and the second outer ring. A second preload applying unit is disposed between the second outer ring and a second wall portion, and presses the second outer ring toward the first outer ring and a first wall portion.

### CROSS-REFERENCE TO RELATED APPLICATIONS

This application is based upon and claims the benefit of priority from Japanese Patent Application No. 2024-157196 filed on Sep. 11, 2024, the contents of which are incorporated herein by reference.

### BACKGROUND OF THE INVENTION

### Field of the Invention

The present invention relates to a preloaded bearing device and a preload adjustment method.

### Description of the Related Art

A preloaded bearing device that has been conventionally used in a state where a constant-pressure preload is applied to a plurality of angular bearings is disclosed in, for example, JP 2007-113777 A.

### SUMMARY OF THE INVENTION

In the above-described related art, an elastic member that generates a preload is disposed between an inner ring-tightening nut and an inner ring. By adjusting the degree of tightening of the inner ring-tightening nut, the preload on the angular bearings can be adjusted. However, since the change in the preload is too sensitive to the change in the position of the inner ring-tightening nut, there is a problem that it is difficult to adjust the preload. Further, there is a problem that the preload changes (increases) due to a temperature rise caused by heat generation during operation (during rotation), and the preload cannot be kept constant.

The present invention has the object of solving the aforementioned problem.

According to a first aspect of the present disclosure, there is provided a preloaded bearing device, comprising: a rotary shaft; a housing configured to surround the rotary shaft; a first angular bearing unit disposed between the rotary shaft and the housing; a second angular bearing unit disposed between the rotary shaft and the housing so as to be separated from the first angular bearing unit in an axial direction of the rotary shaft; and a preload applying mechanism configured to generate a preload by elastically pressing, in the axial direction, a first outer ring that is an outer ring of the first angular bearing unit, and a second outer ring that is an outer ring of the second angular bearing unit, wherein the first outer ring and the second outer ring are accommodated in an outer ring accommodating portion provided in the housing, the first outer ring and the second outer ring are disposed between a first wall portion and a second wall portion, the first wall portion being a wall of the outer ring accommodating portion on one side in the axial direction, the second wall portion being a wall of the outer ring accommodating portion on another side in the axial direction, the first outer ring is disposed between the first wall portion and the second outer ring, the second outer ring is disposed between the first outer ring and the second wall portion, and the preload applying mechanism includes: a first preload applying unit disposed between the first outer ring and the second outer ring and configured to press the first outer ring toward the first wall portion and press the second outer ring toward the second wall portion; and a second preload applying unit disposed between the second outer ring and the second wall portion and configured to press the second outer ring toward the first outer ring and the first wall portion.

According to a second aspect of the present disclosure, there is provided a preload adjustment method for the preloaded bearing device according to the first aspect, the preload adjustment method comprising: measuring a parameter for preload adjustment by performing a rotation test of the preloaded bearing device; and adjusting a dimension of a specific portion of the housing based on the parameter to perform the preload adjustment.

According to the present disclosure, preload adjustment after assembly of a preloaded bearing device can be performed with high accuracy.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a cross-sectional view of a spindle device including a preloaded bearing device according to an embodiment of the present disclosure;

FIG. 2 is a flowchart of a preload adjustment method;

FIG. 3 is a conceptual diagram of the preloaded bearing device shown in FIG. 1; and

FIG. 4 is a conceptual diagram of a preloaded bearing device according to a comparative example.

### DETAILED DESCRIPTION OF THE INVENTION

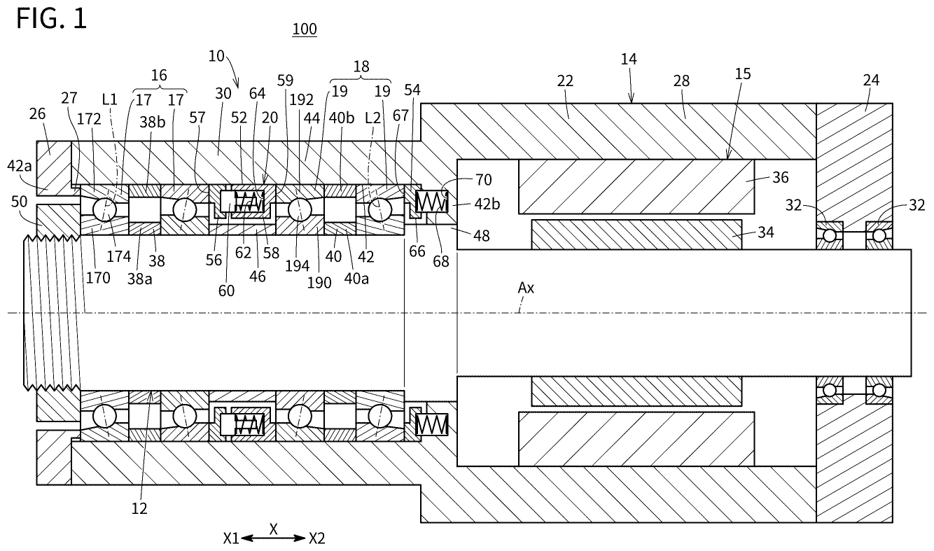

As shown in FIG. 1, a preloaded bearing device 10 is provided in a spindle device 100. The spindle device 100 constitutes a part of a machine tool, and is a rotational drive unit that rotates a tool. The tool is, for example, a drill, a grinding wheel, or the like. The spindle device 100 includes a rotary shaft 12, a housing 14, a motor 15, a first angular bearing unit 16, a second angular bearing unit 18, and a preload applying mechanism 20.

The rotary shaft 12 is a main shaft member of the spindle device 100. The rotary shaft 12 rotates about an axis Ax. Hereinafter, regarding the spindle device 100 and the respective components thereof, one side (X1 direction side) in the axial direction (X direction) of the rotary shaft 12 is referred to as a “distal end side” or a “distal end portion”, and the other side (X2 direction side) in the axial direction is referred to as a “proximal end side” or a “proximal end portion”. A tool (not shown) is attached to a distal end portion of the rotary shaft 12.

The housing 14 is a tubular body surrounding the rotary shaft 12. The housing 14 extends in the axial direction. The housing 14 includes a housing body 22, an end plate 24, and a lid member 26. The housing body 22 includes a motor housing portion 28 and a bearing housing portion 30. The motor housing portion 28 surrounds the motor 15. The bearing housing portion 30 surrounds the first angular bearing unit 16 and the second angular bearing unit 18.

The end plate 24 is fixed to a proximal end portion of the housing body 22 by a non-illustrated fastening component (such as a bolt). The end plate 24 is a member having a circular ring shape. A plurality of bearings 32 are disposed between the inner peripheral portion of the end plate 24 and the rotary shaft 12. Only one bearing 32 may be disposed. The lid member 26 is fixed to a distal end portion of the housing body 22 by a non-illustrated fastening component (such as a bolt). The lid member 26 has a circular ring shape.

The motor 15 is a rotating electrical machine for rotating the rotary shaft 12. The motor 15 includes a rotor 34 and a stator 36. The rotor 34 is fixed to the rotary shaft 12. The stator 36 is fixed to the housing 14. Specifically, the stator 36 is fixed to the motor housing portion 28 of the housing body 22.

The first angular bearing unit 16 includes a plurality of first angular bearings 17 arranged in the axial direction. In the present embodiment, the number of the first angular bearings 17 is two. A first spacer 38 having a circular ring shape is disposed between the two first angular bearings 17. The first spacer 38 includes an inner spacer 38a and an outer spacer 38b. In another aspect, the number of the first angular bearings 17 may be one or three or more.

Each of the first angular bearings 17 includes a first inner ring 170, a first outer ring 172, and a first ball 174. The first outer ring 172 of each of the first angular bearings 17 is slidable in the axial direction with respect to the housing body 22. In each of the first angular bearings 17, a line of action L1 of force connecting a contact point between the first inner ring 170 and the first ball 174 and a contact point between the first outer ring 172 and the first ball 174 (hereinafter referred to as a “first line of action L1”) is inclined with respect to the radial direction.

The first line of action L1 is inclined with respect to the radial direction such that the radially outer side approaches the second angular bearing unit 18. The inner spacer 38a of the first spacer 38 is disposed between the two first inner rings 170. The outer spacer 38b of the first spacer 38 is disposed between the two first outer rings 172. The outer spacer 38b is slidable in the axial direction with respect to the housing body 22.

The second angular bearing unit 18 includes a plurality of second angular bearings 19 arranged in the axial direction. In the present embodiment, the number of the second angular bearings 19 is two. A second spacer 40 having a circular ring shape is disposed between the two second angular bearings 19. The second spacer 40 includes an inner spacer 40a and an outer spacer 40b. In another aspect, the number of the second angular bearings 19 may be one or three or more.

Each of the second angular bearings 19 includes a second inner ring 190, a second outer ring 192, and a second ball 194. The second outer ring 192 of each of the second angular bearings 19 is slidable in the axial direction with respect to the housing body 22. In each of the second angular bearings 19, a line of action L2 of force connecting a contact point between the second inner ring 190 and the second ball 194 and a contact point between the second outer ring 192 and the second ball 194 (hereinafter referred to as a “second line of action L2”) is inclined with respect to the radial direction.

The second line of action L2 is inclined with respect to the radial direction such that the radially outer side approaches the first angular bearing unit 16. The inner spacer 40a of the second spacer 40 is disposed between the two second inner rings 190. The outer spacer 40b of the second spacer 40 is disposed between the two second outer rings 192. The outer spacer 40b is slidable in the axial direction with respect to the housing body 22.

The first outer rings 172 and the second outer rings 192 are accommodated in an outer ring accommodating portion 42 provided in the housing 14. The lid member 26 closes one side of the outer ring accommodating portion 42. The first outer rings 172 and the second outer rings 192 are disposed between a first wall portion 42a, which is a wall of the outer ring accommodating portion 42 on one side (X1 direction side) in the axial direction, and a second wall portion 42b, which is a wall of the outer ring accommodating portion 42 on the other side (X2 direction side) in the axial direction. The first wall portion 42a constitutes a part of the lid member 26.

The lid member 26 is provided with a protrusion 27 protruding toward the first outer rings 172. The protrusion 27 is in contact with the first outer ring 172, which is on the distal end side, of the first angular bearing unit 16, and presses the first outer ring 172 in the axial direction. The protrusion 27 has an annular shape extending in the circumferential direction of the housing 14. The housing body 22 includes a surrounding wall portion 44 extending in the axial direction from the second wall portion 42b and surrounding the first outer rings 172 and the second outer rings 192. The first outer rings 172 are disposed between the first wall portion 42a and the second outer rings 192. The second outer rings 192 are disposed between the first outer rings 172 and the second wall portion 42b.

A center spacer 46 having an annular shape is disposed between the first inner ring 170 and the second inner ring 190 that are adjacent to each other in the axial direction. The first angular bearing unit 16 and the second angular bearing unit 18 are disposed between an annular protrusion 48 provided on the outer peripheral portion of the rotary shaft 12 and a tightening nut 50 attached to the rotary shaft 12. The annular protrusion 48 is in contact with the second outer ring 192 of the second angular bearing 19, which is on the proximal end side, of the second angular bearing unit 18.

The tightening nut 50 is in contact with the first inner ring 170 of the first angular bearing 17, which is on the distal end side, of the first angular bearing unit 16. The tightening nut 50 is disposed on the inner side of the lid member 26. The two first inner rings 170 of the first angular bearing unit 16 and the two second inner rings 190 of the second angular bearing unit 18 are positioned and fixed in the axial direction by being tightened in the axial direction by the tightening nut 50.

The preload applying mechanism 20 generates a preload by elastically pressing, in the axial direction, the first outer rings 172 of the first angular bearing unit 16 and the second outer rings 192 of the second angular bearing unit 18. The preload applying mechanism 20 includes a first preload applying unit 52 and a second preload applying unit 54.

The first preload applying unit 52 is disposed between the first outer ring 172 and the second outer ring 192 that are adjacent to each other in the axial direction. The first preload applying unit 52 presses the first outer rings 172 toward the first wall portion 42a and presses the second outer rings 192 toward the second wall portion 42b. The first preload applying unit 52 is slidable in the axial direction with respect to the housing body 22.

The first preload applying unit 52 includes a first pressing member 56, a second pressing member 58, a piston 60, and an elastic member 62. The first pressing member 56 presses the first outer rings 172. The first pressing member 56 is formed in a circular ring shape surrounding the rotary shaft 12. The first pressing member 56 includes a first contact protrusion 57 protruding toward the first outer rings 172. The first contact protrusion 57 has an annular shape extending in the circumferential direction. A plurality of the first contact protrusions 57 may be provided at intervals in the circumferential direction.

The second pressing member 58 presses the second outer rings 192. The second pressing member 58 is formed in a circular ring shape surrounding the rotary shaft 12. The second pressing member 58 includes a second contact protrusion 59 protruding toward the second outer rings 192. The second contact protrusion 59 has an annular shape extending in the circumferential direction. A plurality of the second contact protrusions 59 may be provided at intervals in the circumferential direction. The second pressing member 58 includes an accommodation groove 64.

The accommodation groove 64 is provided in plurality. The plurality of accommodation grooves 64 are provided at intervals in the circumferential direction of the housing 14.

The piston 60 is disposed between the first pressing member 56 and the second pressing member 58. The piston 60 is in contact with the first pressing member 56. A part of the piston 60 is accommodated in the accommodation groove 64 of the second pressing member 58. The piston 60 is provided in plurality. The plurality of pistons 60 are provided at intervals in the circumferential direction of the housing 14.

The elastic member 62 (hereinafter referred to as a “first elastic member 62”) is disposed between the first pressing member 56 and the second pressing member 58. The first elastic member 62 is disposed between the piston 60 and the second pressing member 58. The first elastic member 62 presses the piston 60 toward the first pressing member 56. The first elastic member 62 is accommodated in the accommodation groove 64. The first elastic member 62 is, for example, a coil spring. The first elastic member 62 may be constituted by a plurality of disc springs arranged in the axial direction. The first elastic member 62 is provided in plurality. The plurality of first elastic members 62 are provided at intervals in the circumferential direction.

It should be noted that the accommodation grooves 64 may be provided in the first pressing member 56. In this case, the piston 60 is in contact with the second pressing member 58, and the first elastic member 62 is disposed between the first pressing member 56 and the piston 60.

The second preload applying unit 54 is disposed between the second outer ring 192 and the second wall portion 42b that are adjacent to each other. The second preload applying unit 54 presses the second outer rings 192 toward the first outer rings 172 and the first wall portion 42a. The second preload applying unit 54 includes an annular pressing member 66 and an elastic member 68. The annular pressing member 66 is formed in a circular ring shape surrounding the rotary shaft 12. The annular pressing member 66 presses the second outer rings 192. The annular pressing member 66 is slidable in the axial direction with respect to the housing body 22. The annular pressing member 66 includes a pressing protrusion 67 protruding toward the second outer rings 192. The pressing protrusion 67 has an annular shape extending in the circumferential direction. A plurality of the pressing protrusions 67 may be provided at intervals in the circumferential direction.

The elastic member 68 (hereinafter referred to as a “second elastic member 68”) presses the annular pressing member 66 toward the second outer rings 192. The second elastic member 68 is accommodated in a spring placement groove 70 provided in the second wall portion 42b of the housing body 22. The spring placement groove 70 may be provided in a member different from the housing body 22. The second elastic member 68 is provided in plurality. The plurality of second elastic members 68 are provided at intervals in the circumferential direction. Therefore, a plurality of the spring placement grooves 70 are provided at intervals in the circumferential direction.

The second elastic members 68 are each a coil spring, for example. The second elastic member 68 may be constituted by a plurality of disc springs arranged in the axial direction. The spring constant of the second elastic member 68 of the second preload applying unit 54 is smaller than the spring constant of the first elastic member 62 of the first preload applying unit 52. That is, the spring constant of the second preload applying unit 54 is smaller than the spring constant of the first preload applying unit 52. The spring constant of the second elastic member 68 is, for example, 30% to 70% of the spring constant of the first elastic member 62. Alternatively, the spring constant of the second elastic member 68 is, for example, 40% to 60% of the spring constant of the first elastic member 62.

Next, a preload adjustment method for the preloaded bearing device 10 will be described.

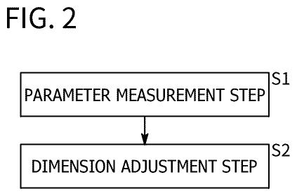

As shown in FIG. 2, the preload adjustment method includes a parameter measurement step S1 and a dimension adjustment step S2. In the parameter measurement step S1, after the preloaded bearing device 10 (the spindle device 100) is assembled, a rotation test of the preloaded bearing device 10 is performed to measure parameters for preload adjustment. In the parameter measurement step S1, the preloaded bearing device 10, for which the parameters are to be measured, is in a temporarily assembled state. When the preloaded bearing device 10 is assembled, it is assembled so as to have a specified pressing margin with respect to the first outer rings 172. The specified pressing margin is an adjustment initial value, and is an initial protruding length of the protrusion 27 of the lid member 26. Basically, it is preferable to set the initial protruding length of the protrusion 27 in anticipation of adjusting the protruding length by cutting the protrusion 27. The parameters include at least the temperature of the first angular bearing unit 16 or the temperature of the second angular bearing unit 18. The parameters include the rigidity of the preloaded bearing device 10.

In the dimension adjustment step S2, the preload adjustment is performed by adjusting the dimension of a specific portion of the housing 14 based on the parameters obtained by the measurement. Specifically, in the dimension adjustment step S2, the preload adjustment is performed by adjusting (increasing or decreasing) the protruding length of the protrusion 27, which is the specific portion.

In the dimension adjustment step S2, a preload is calculated based on the temperature measured in the rotation test. In this case, the preload can be calculated (acquired) with reference to a correspondence table (reference table) prepared in advance and indicating a relationship between the temperature and the preload. Then, the pressing margin is adjusted based on the acquired preload. Specifically, after the lid member 26 is removed from the housing body 22, the protruding length of the protrusion 27 is adjusted. In this case, the adjustment amount of the pressing margin can be calculated (acquired) with reference to a correspondence table (reference table) prepared in advance and indicating a relationship between the preload and the pressing margin. The preload decreases as the pressing margin increases (details of which will be described later). Therefore, if the pressing margin is reduced, the preload is increased. By cutting (shortening) the protrusion 27, the pressing margin can be reduced.

After the dimension of the protrusion 27 is adjusted so that a desired preload is obtained, the preloaded bearing device 10 (the spindle device 100) is reassembled. Specifically, in the case where the preload acquired based on the temperature is smaller than a desired set value (set range), the protrusion 27 is shortened so that the set value is attained. On the other hand, in the case where the preload acquired based on the temperature is larger than the desired set value, the protrusion 27 is lengthened so that the set value is attained. Instead of lengthening the protrusion 27, an additional spacer may be disposed.

It should be noted that, in the case where the temperature measured in the rotation test in the parameter measurement step S1 is higher than a temperature reference value (temperature upper limit value), the lid member 26 with an increased pressing margin (with an increased length of the protrusion 27) is prepared, and the preloaded bearing device 10 is reassembled. In the case where the lid member 26 with an increased pressing margin is prepared, the lid member 26 may be processed so as to increase the pressing margin. If the protruding length of the protrusion 27 is increased, the preload is reduced, and thus the temperature during rotation is also reduced. It should be noted that, in the case where the rigidity in the axial direction of the preloaded bearing device 10 obtained in the parameter measurement step S1 is lower than a reference value (rigidity lower limit value), the preload is increased by reducing the pressing margin.

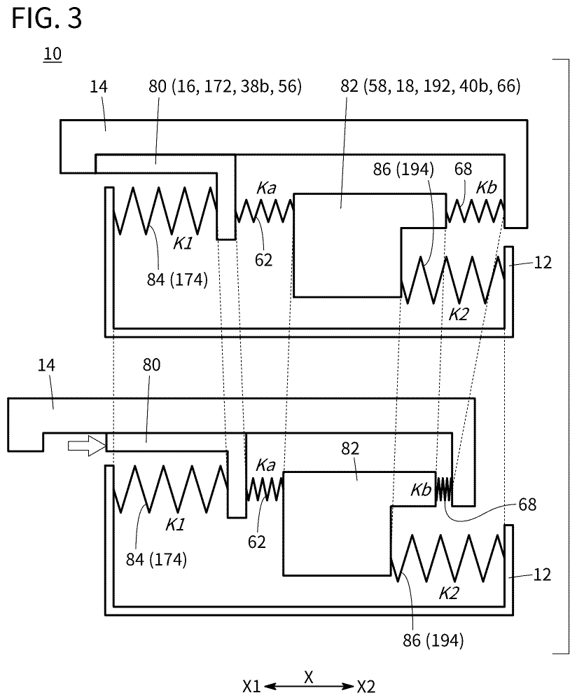

FIG. 3 is a conceptual diagram of the preloaded bearing device 10. A first movable element 80 and a second movable element 82 are movable relative to the housing 14 and the rotary shaft 12 in the axial direction. The first movable element 80 represents, as one element, the two first outer rings 172 of the first angular bearing unit 16, the outer spacer 38b, and the first pressing member 56. The second movable element 82 represents, as one element, the second pressing member 58, the two second outer rings 192 of the second angular bearing unit 18, the outer spacer 40b, and the annular pressing member 66.

In FIG. 3, the first balls 174 of the first angular bearing unit 16 and the second balls 194 of the second angular bearing unit 18 are represented as spring elements (a first spring 84 and a second spring 86). K1 is the spring constant of the first spring 84 (the first balls 174). K2 is the spring constant of the second spring 86 (the second balls 194). Ka is the spring constant of the first elastic member 62 of the first preload applying unit 52. Kb is the spring constant of the second elastic member 68 of the second preload applying unit 54. It should be noted that K1 and K2 are much greater than Ka and Kb.

FIG. 3 shows how the lengths of the first spring 84 and the second spring 86 change depending on the magnitude (length) of the pressing margin with respect to the first movable element 80. As shown in the lower diagram of FIG. 3, when the pressing margin (the amount of relative displacement of the first movable element 80 in the axial direction with respect to the housing 14) is increased, the first elastic member 62 of the first preload applying unit 52 and the second elastic member 68 of the second preload applying unit 54 contract in the axial direction. In this case, since Kb is smaller than Ka, the amount of contraction of the second elastic member 68 is larger than the amount of contraction of the first elastic member 62. On the other hand, the rotary shaft 12 and the housing 14 are displaced relative to each other in the axial direction. As a result of the contraction of the first elastic member 62 and the second elastic member 68 and the relative displacement between the rotary shaft 12 and the housing 14 in the axial direction, the first spring 84 and the second spring 86 expand. The expansion of the first spring 84 and the second spring 86 means a decrease in the preload. From this, it is understood that the preload decreases as the pressing margin increases. The expansion amount of each of the first spring 84 and the second spring 86 is much smaller relative to the amount of increase in the pressing margin. Therefore, the amount of change in the preload is small relative to the amount of change in the pressing margin. In other words, the change in the preload is insensitive to the amount of change in the pressing margin. Therefore, the preload adjustment is easy, and the preload adjustment after assembly can be performed with high accuracy.

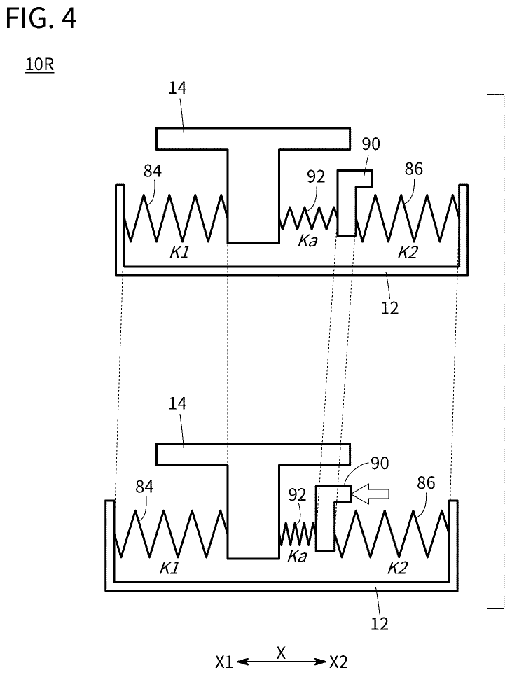

On the other hand, FIG. 4 is a conceptual diagram of a preloaded bearing device 10R according to a comparative example. In the preloaded bearing device 10R, by pressing a movable element 90 in the axial direction, the movable element 90 is displaced relative to the housing 14 in the axial direction, and therefore, it is possible to adjust the preload. However, since most of the displacement amount of the movable element 90 is absorbed as the contraction amount of the elastic member 92, the respective expansion amounts of the first spring 84 and the second spring 86 increase. Therefore, the amount of change in the preload is large relative to the amount of change in the pressing margin with respect to the movable element 90. In other words, the change in the preload is sensitive to the amount of change in the pressing margin, and therefore, it is difficult to perform the preload adjustment with high accuracy. In addition, the movable element 90 must be disposed inside the housing 14, and the preload adjustment is therefore difficult because disassembly and subsequent reassembly or an appropriate adjustment mechanism is required in order to adjust the preload.

It should be noted that, since the respective components of the preloaded bearing device 10 are not moved at all by a force in the X2 direction less than a spring load (a force with which the spring is compressed) of the second elastic member 68 in FIG. 3, the rigidity of the preloaded bearing device 10 is equivalent to that of a preloaded bearing device with a general constant-pressure preload structure (the preloaded bearing device 10R in FIG. 4). Therefore, the rigidity of the preloaded bearing device 10 in the X2 direction is not reduced due to the position and the direction in which the second elastic member 68 is disposed.

The preloaded bearing device 10 according to the present embodiment shown in FIG. 1 has the following effects.

The preloaded bearing device 10 includes not only the first preload applying unit 52 disposed between the first angular bearing unit 16 and the second angular bearing unit 18 but also the second preload applying unit 54 disposed axially outside the first angular bearing unit 16 and the second angular bearing unit 18. Therefore, the preload adjustment after the assembly of the preloaded bearing device 10 can be performed with high accuracy.

The spring constant of the second preload applying unit 54 (the second elastic member 68) is smaller than the spring constant of the first preload applying unit 52 (the first elastic member 62). According to such a configuration, it is possible to more reliably perform preload adjustment with high accuracy.

The first preload applying unit 52 presses the first outer rings 172 using the first pressing member 56 and presses the second outer rings 192 using the second pressing member 58, and the piston 60 and the first elastic member 62 are disposed between the first pressing member 56 and the second pressing member 58. According to such a configuration, a pressing force can be favorably applied to the first angular bearing unit 16 and the second angular bearing unit 18.

The first pressing member 56 and the second pressing member 58 are each formed in a circular ring shape, and a plurality of combinations of the piston 60 and the first elastic member 62 are arranged at intervals in the circumferential direction. According to such a configuration, the pressing force in the axial direction can be uniformly generated in the circumferential direction.

The second preload applying unit 54 includes the annular pressing member 66 formed in a circular ring shape, and the second elastic member 68 that presses the annular pressing member 66 toward the second outer rings 192. According to such a configuration, a pressing force can be favorably applied to the second angular bearing unit 18.

The housing 14 includes the lid member 26 that is connected to the housing body 22 and closes one side of the outer ring accommodating portion 42. The preload adjustment can be performed by adjusting the dimension of the lid member 26. According to such a configuration, in a preload adjustment process after the temporary assembly, the preload can be easily adjusted by adjusting the dimension of the lid member 26. That is, the preload adjustment can be performed by disassembly and reassembly with a small number of process steps after the assembly of the preloaded bearing device 10.

The lid member 26 is provided with the protrusion 27 protruding toward the first outer rings 172. By adjusting the protruding length of the protrusion 27, it is possible to adjust the preload applied to the first angular bearing unit 16 and the second angular bearing unit 18. According to such a configuration, the preload can be easily adjusted by adjusting the dimension of the protrusion 27.

The following supplementary notes are further disclosed in relation to the above-described embodiment.

### Supplementary Note 1

The preloaded bearing device (10) according to the present disclosure includes: the rotary shaft (12); the housing (14) configured to surround the rotary shaft; the first angular bearing unit (16) disposed between the rotary shaft and the housing; the second angular bearing unit (18) disposed between the rotary shaft and the housing so as to be separated from the first angular bearing unit in the axial direction of the rotary shaft; and the preload applying mechanism (20) configured to generate a preload by elastically pressing, in the axial direction, the first outer ring (172) that is an outer ring of the first angular bearing unit, and the second outer ring (192) that is an outer ring of the second angular bearing unit, wherein the first outer ring and the second outer ring are accommodated in the outer ring accommodating portion (42) provided in the housing, the first outer ring and the second outer ring are disposed between the first wall portion (42a) and the second wall portion (42b), the first wall portion being a wall of the outer ring accommodating portion on one side in the axial direction, the second wall portion being a wall of the outer ring accommodating portion on another side in the axial direction, the first outer ring is disposed between the first wall portion and the second outer ring, the second outer ring is disposed between the first outer ring and the second wall portion, and the preload applying mechanism includes: the first preload applying unit (52) disposed between the first outer ring and the second outer ring and configured to press the first outer ring toward the first wall portion and press the second outer ring toward the second wall portion; and the second preload applying unit (54) disposed between the second outer ring and the second wall portion and configured to press the second outer ring toward the first outer ring and the first wall portion. According to such a configuration, the preloaded bearing device includes not only the first preload applying unit disposed between the first angular bearing unit and the second angular bearing unit but also the second preload applying unit disposed axially outside the first angular bearing unit and the second angular bearing unit. Therefore, the preload adjustment after assembly can be performed with high accuracy.

### Supplementary Note 2

In the preloaded bearing device according to Supplementary Note 1, the spring constant of the second preload applying unit may be smaller than the spring constant of the first preload applying unit. According to such a configuration, it is possible to more reliably perform preload adjustment with high accuracy.

### Supplementary Note 3

In the preloaded bearing device according to Supplementary Note 1 or 2, the first preload applying unit may include: the first pressing member (56) configured to press the first outer ring; the second pressing member (58) configured to press the second outer ring; the piston (60) disposed between the first pressing member and the second pressing member; and the elastic member (62) disposed between the first pressing member and the second pressing member and configured to press the piston toward the first pressing member or the second pressing member. According to such a configuration, a pressing force can be favorably applied to the first angular bearing unit and the second angular bearing unit.

### Supplementary Note 4

In the preloaded bearing device according to Supplementary Note 3, each of the first pressing member and the second pressing member may be formed in a circular ring shape surrounding the rotary shaft, the piston may be provided in plurality, the elastic member may be provided in plurality, the plurality of pistons may be provided at intervals in the circumferential direction of the housing, and the plurality of elastic members may be provided at intervals in the circumferential direction. According to such a configuration, the pressing force in the axial direction can be uniformly generated in the circumferential direction.

### Supplementary Note 5

In the preloaded bearing device according to any one of Supplementary Notes 1 to 4, the second preload applying unit may include: the annular pressing member (66) formed in a circular ring shape surrounding the rotary shaft, and configured to press the second outer ring; and the elastic member (68) configured to press the annular pressing member toward the second outer ring. According to such a configuration, a pressing force can be favorably applied to the second angular bearing unit.

### Supplementary Note 6

In the preloaded bearing device according to any one of Supplementary Notes 1 to 5, the housing may include: the housing body (22) including the second wall portion, and the surrounding wall portion (44) extending in the axial direction from the second wall portion and configured to surround the first outer ring and the second outer ring; and the lid member (26) connected to the housing body, including the first wall portion, and configured to close the one side of the outer ring accommodating portion, wherein the preload applied to the first angular bearing unit and the second angular bearing unit can be adjusted by adjusting the dimension of the lid member. According to such a configuration, in the preload adjustment process after the temporary assembly, the preload can be easily adjusted by adjusting the dimension of the lid member.

### Supplementary Note 7

In the preloaded bearing device according to Supplementary Note 6, the lid member may be provided with the protrusion (27) protruding toward the first outer ring. According to such a configuration, the preload can be easily adjusted by adjusting the dimension of the protrusion.

### Supplementary Note 8

The preload adjustment method according to the present disclosure is a preload adjustment method for the preloaded bearing device according to Supplementary Note 1, the method including: the parameter measurement step (S1) of measuring a parameter for preload adjustment by performing a rotation test of the preloaded bearing device; and the dimension adjustment step (S2) of adjusting the dimension of a specific portion of the housing based on the parameter to perform the preload adjustment.

### Supplementary Note 9

In the preload adjustment method according to Supplementary Note 8, the housing may include: the housing body including the second wall portion, and the surrounding wall portion extending in the axial direction from the second wall portion and configured to surround the first outer ring and the second outer ring; and the lid member connected to the housing body, including the first wall portion, and configured to close the one side of the outer ring accommodating portion, wherein the lid member may be provided with the protrusion protruding toward the first outer ring, and in the dimension adjustment step, the protruding length of the protrusion that is the specific portion may be adjusted to perform the preload adjustment.

### Supplementary Note 10

In the preload adjustment method according to Supplementary Note 8, the parameter may be the temperature of the first angular bearing unit or the temperature of the second angular bearing unit, or the rigidity of the preloaded bearing device.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A preloaded bearing device, comprising:
a rotary shaft;
a housing configured to surround the rotary shaft;
a first angular bearing unit disposed between the rotary shaft and the housing;
a second angular bearing unit disposed between the rotary shaft and the housing so as to be separated from the first angular bearing unit in an axial direction of the rotary shaft; and
a preload applying mechanism configured to generate a preload by elastically pressing, in the axial direction, a first outer ring that is an outer ring of the first angular bearing unit, and a second outer ring that is an outer ring of the second angular bearing unit,
wherein the first outer ring and the second outer ring are accommodated in an outer ring accommodating portion provided in the housing,
the first outer ring and the second outer ring are disposed between a first wall portion and a second wall portion, the first wall portion being a wall of the outer ring accommodating portion on one side in the axial direction, the second wall portion being a wall of the outer ring accommodating portion on another side in the axial direction,
the first outer ring is disposed between the first wall portion and the second outer ring,
the second outer ring is disposed between the first outer ring and the second wall portion, and
the preload applying mechanism includes:
a first preload applying unit disposed between the first outer ring and the second outer ring and configured to press the first outer ring toward the first wall portion and press the second outer ring toward the second wall portion; and
a second preload applying unit disposed between the second outer ring and the second wall portion and configured to press the second outer ring toward the first outer ring and the first wall portion.

2. The preloaded bearing device according to claim 1, wherein
a spring constant of the second preload applying unit is smaller than a spring constant of the first preload applying unit.

3. The preloaded bearing device according to claim 1, wherein
the first preload applying unit includes:
a first pressing member configured to press the first outer ring;
a second pressing member configured to press the second outer ring;
a piston disposed between the first pressing member and the second pressing member; and
an elastic member disposed between the first pressing member and the second pressing member and configured to press the piston toward the first pressing member or the second pressing member.

4. The preloaded bearing device according to claim 3, wherein
each of the first pressing member and the second pressing member is formed in a circular ring shape surrounding the rotary shaft,
the piston is provided in plurality, the plurality of pistons being provided at intervals in a circumferential direction of the housing, and
the elastic member is provided in plurality, the plurality of elastic members being provided at intervals in the circumferential direction.

5. The preloaded bearing device according to claim 1, wherein
the second preload applying unit includes:
an annular pressing member formed in a circular ring shape surrounding the rotary shaft, and configured to press the second outer ring; and
an elastic member configured to press the annular pressing member toward the second outer ring.

6. The preloaded bearing device according to claim 1, wherein
the housing includes:
a housing body including the second wall portion, and a surrounding wall portion extending in the axial direction from the second wall portion and configured to surround the first outer ring and the second outer ring; and
a lid member connected to the housing body, including the first wall portion, and configured to close the one side of the outer ring accommodating portion, and
a preload applied to the first angular bearing unit and the second angular bearing unit is adjustable by adjusting a dimension of the lid member.

7. The preloaded bearing device according to claim 6, wherein
the lid member is provided with a protrusion protruding toward the first outer ring.

8. A preload adjustment method for the preloaded bearing device according to claim 1, the preload adjustment method comprising:
measuring a parameter for preload adjustment by performing a rotation test of the preloaded bearing device; and
adjusting a dimension of a specific portion of the housing based on the parameter to perform the preload adjustment.

9. The preload adjustment method according to claim 8, wherein
the housing includes:
a housing body including the second wall portion, and a surrounding wall portion extending in the axial direction from the second wall portion and configured to surround the first outer ring and the second outer ring; and
a lid member connected to the housing body, including the first wall portion, and configured to close the one side of the outer ring accommodating portion,
the lid member is provided with a protrusion protruding toward the first outer ring, and
in the adjusting of the dimension of the specific portion, a protruding length of the protrusion that is the specific portion is adjusted to perform the preload adjustment.

10. The preload adjustment method according to claim 8, wherein
the parameter is a temperature of the first angular bearing unit or a temperature of the second angular bearing unit, or a rigidity of the preloaded bearing device.
